(19) United States
(12) Patent Application Publication
(10) Pub. No.: US 2025/0057409 A1
(43) Pub. Date: Feb. 20, 2025

(54) CENTERING APPARATUS AND METHOD FOR DETERMINING OPTICAL CENTERING PARAMETERS OF A SPECTACLE WEARER

(71) Applicant: Rodenstock GmbH, Muenchen (DE)

(72) Inventors: Stephan Trumm, Muenchen (DE); Michel Stutz, Muenchen (DE); Lukas Gromann, Freising (DE)

(21) Appl. No.: 18/721,557

(22) PCT Filed: Dec. 19, 2022
(86) PCT No.: PCT/EP2022/086767

§ 371 Date: Jun. 18, 2024

(30) Foreign Application Priority Data
Dec. 23, 2021 (DE) 10 2021 214 979.0

(51) Int. Cl. A61B 3/00; A61B 3/14; G02C 7/02

(52) U.S. Cl. CPC A61B 3/0091; A61B 3/14; G02C 7/027

(57) ABSTRACT

A centering device of a spectacle wearer has a fixation target that generates a flatly extended light field at a measurement location for illuminating an eye of the spectacle wearer. A measurer ascertains a measurement position of the eye when viewing the light field generated by the fixation target. A corrector includes deviation information about a deviation of the light field actually generated at the measurement location by the fixation target from a setpoint light field predetermined at the measurement location, and corrects the ascertained measurement position of the eye when viewing the light field generated at the measurement location, considering the deviation information, to an eye setpoint position which the eye would prospectively adopt at the measurement location if it were to view the predetermined setpoint light field there. A parameter calculator ascertains, based on the eye setpoint position, an optical centering parameter to be determined.

### TECHNICAL FIELD

The invention relates to a centering device and a method for determining optical centering parameters of a spectacle wearer and to a use.

### BACKGROUND

The introduction of individually optimized spectacle lenses makes it possible to respond to the needs of persons with visual impairments and, for example, to provide spectacle lenses with individually optimized visual zones. Individually fitted spectacle lenses allow for optimal correction of optical visual impairments of a user of the spectacle lenses. Individual calculation and fitting of spectacle lenses is also possible for sports spectacles which are characterized by large deflections, face form and forward inclination angles.

In order to fully exploit the optical advantages of individual spectacle lenses, in particular customized progressive lenses, it is necessary to calculate and manufacture these spectacle lenses with knowledge of the user's posture of use and to wear them in accordance with the posture of use used for calculation and manufacture. The posture of use depends on a plurality of optical centering parameters, for example the pupillary distance of the user, the face form angle, the spectacle lens forward inclination, the spectacle frame, the corneal vertex distance of the system of spectacles and eye and the fitting height of the spectacle lenses. These and other parameters which can be employed or are necessary to describe the posture of use are contained in relevant standards such as DIN EN ISO 13666, DIN 58 208, DIN EN ISO 8624 and DIN 5340, for example, and can be found therein.

Here, the spectacle lenses may be arranged or centered in a spectacle frame in accordance with the optical centering parameters which were used for manufacturing so that the spectacle lenses are actually worn by the spectacle wearer in the posture of use in accordance with the optical centering parameters.

In order to determine the individual optical centering parameters, opticians have a plurality of measuring devices at their disposal, in particular centering devices. Such a centering device is known, for example, from DE 10 2005 003 699 A1. Here, image data of the head of the spectacle wearer is generated from at least two image capturing directions, and the optical centering parameters are ascertained from these. Here, the gaze of the spectacle wearer in the posture of use may be set, for example, by the subject fixating the root of their nose in a mirror image. It is also possible to use a speckle pattern or a luminous dot. Here, an aim is to align the gaze of the spectacle wearer such that the actual alignment of the eyes corresponds to the gaze behavior to be measured.

From DE 10 2008 003 906 B4, there is known a fixation target as an aid for aligning the gaze direction of the spectacle wearer for such a centering device. Here, the fixation target generates a light field for controlling the gaze of the spectacle wearer while image data of the head of the spectacle wearer is generated by the centering device. This is particularly helpful for people with visual defects who are unable to perform normal visual tasks, e.g. due to high visual defects and/or strabismus.

In technical optics, adjustable elements such as lens holders, for example, are used as fixation targets, with which the overall system can be set such that the optical system fulfills the desired requirements. Here, in particular high-precision (and thus expensive) individual elements such as lenses, tubes, diaphragms, etc. may be used to align the light field of the fixation target.

As an alternative (or in addition) to the use of such high-precision individual elements, the previously known fixation targets require at least one complex opto-mechanical system having individual elements (such as micrometer screws, for example) which are only required for adjusting the fixation target. Here, in order to precisely align the light field generated by the fixation target, an elaborate manual adjustment of the overall system is required, which is time-consuming and cost-intensive.

Thus, the costs of the previously known fixation targets are high since its individual components must be designed with high precision and/or must be adjusted with high effort. In particular in the case of the lens of the fixation target, the necessary precision with regard to focal length, lateral position of the center and/or wedge error cannot be achieved with inexpensive production processes.

### SUMMARY

It is an object of the invention to make a centering device having an inexpensive fixation target possible.

This object is achieved by the subject-matters of the independent claims. Preferred embodiments are the subject-matter of the dependent claims.

Prior to the following detailed explanation of the invention, terms which contribute to understanding the invention are defined and described.

Spectacle lenses are, for example, single-vision spectacle lenses, multifocal spectacle lenses, for example progressive lenses, with or without tinting, mirroring and/or polarizing filters.

Two “image capturing units” are, for example, two digital cameras which are positioned separately from one another. It is possible that an image capturing unit preferably comprises a digital camera and at least one optical deflecting element or mirror, wherein image data of a partial region of a head is recorded or generated with the camera by means of the deflecting mirror. Two image capturing units therefore comprise in the same way two in particular digital cameras and at least two deflecting elements and/or mirrors, for example, wherein in each case one digital camera and at least one deflecting mirror constitute an image capturing unit. Furthermore, two image capturing units may also preferably consist of exactly one digital camera and two deflecting elements and/or mirrors, wherein image data is recorded and/or generated with a time delay by means of the digital camera. For example, image data is generated at a first point in time, wherein a partial region of a head is imaged by means of the one deflecting mirror, and image data which images the partial region of the head by means of the other deflecting mirror is generated at a second point in time. Further, the camera may also be arranged in such a way that image data is generated by the camera at the first and/or the second point in time, wherein no deflecting mirror is necessary and/or is arranged between the camera and the head. The two image capturing units may generate image data under different capturing directions.

Two distinct and/or different “capturing directions” are understood to mean that different image data of overlapping partial regions of the head, preferably from one and the same partial region of the head, is generated, in particular that image data and/or comparative image data of identical partial regions of the user's head is generated under different perspective views. Consequently, although the same partial region of the head is imaged, the image data and/or comparative image data differ. Different capturing directions may also be achieved, for example, by generating the image data by at least two image capturing units, wherein effective optical axes of the at least two image capturing units are not parallel.

Dimensioning in the boxing system is understood to mean the system of dimensions as described in the relevant standards, for example in DIN EN ISO 8624 and/or DIN EN ISO 13666 and/or DIN 58 208 and/or DIN 5340. Further, with regard to the boxing system and other conventional terms and parameters used, reference is made to the book “Die Optik des Auges und der Sehhilfen” (“The optics of the eye and visual aids”) by Dr Roland Enders, 1995 Optische Fachveröffentlichung GmbH, Heidelberg, and the book “Optik und Technik der Brille” (“Optics and technology of spectacles”) by Heinz Diepes and Ralf Blendowske, 2002 Verlag Optische Fachveröffentlichungen GmbH, Heidelberg. Reference is also made to the brochure “inform fachberatung für die augenoptik” (“inform specialist advice for ophthalmic optics”) PR publication series of the German central association of opticians and optometrists for opticians, issue 9, “Brillenzentrierung” (“spectacle centering”) ISBN 3-922269-23-0, 1998, in which the boxing system is illustrated as an example, particularly in FIG. 5 and FIG. 6. Furthermore, reference is also made to the book “Brillenanpassung Ein Schulbuch und Leitfaden” (“Spectacle fitting A textbook and guide”) by Wolfgang Schulz and Johannes Eber 1997, DOZ-Verlag, published by the German central association of opticians, DUsseldorf, ISBN 3-922269-21-4, in particular points 1.3, 1.4 and 1.5 and the associated illustrations. The standards, the aforementioned brochure and the aforementioned books constitute an integral part of the disclosure of the present application as far as the definitions of terms are concerned.

The “pupillary distance” substantially corresponds to the distance between the pupil centers, in particular in the direction of zero vision.

The ocular center of rotation of an eye is the point of the eye that remains substantially at rest when the eye is moved, with a fixed head posture, for example when lowering or raising the gaze by rotation of the eye. The ocular center of rotation is thus substantially the center of rotation of the eye.

Effective optical axes of the image capturing units are the regions of lines which emanate from the center point of the respective apertures of the image capturing units perpendicular to these apertures and intersect the imaged partial region of the user's head. In other words, the effective optical axes are in particular the optical axes of the image capturing units, wherein said optical axes are conventionally arranged perpendicular to a lens system of the image capturing units and emanate from the center of the lens system. If there are no further optical elements, such as deflecting mirrors or prisms, for example, in the optical path of the image capturing units, the effective optical axis substantially corresponds to the optical axis of the image capturing unit. However, if further optical elements, for example one or more deflecting mirrors, are arranged in the optical path of the image capturing unit, the effective optical axis no longer corresponds to the optical axis of the image capturing unit since it emanates from the image capturing unit.

Stated differently, the effective optical axis is the region of an optical axis, which may be optically deflected several times, of an image capturing unit, which intersects the user's head without changing direction. The optical axis of the image capturing unit corresponds to a line which emanates from a center point of an aperture of the image capturing unit at a right angle to a plane which comprises the aperture of the image capturing unit, wherein the direction of the optical axis of the image capturing unit is changeable by optical elements such as mirrors and/or prisms, for example. The effective optical axes of two image capturing units may almost intersect.

A “cylindrical lens” is a lens whose curved surfaces are at least partially formed as at least a section of a cylindrical surface or resemble such sections of cylindrical surfaces. In contrast to a spherical lens, which focuses light onto a single point, the cylindrical lens focuses a light beam along a single axis, the “focal axis” and/or “focal line”. Mathematically, a cylindrical lens can be described in a manner corresponding to a spherical lens, but only in one plane. A cylindrical lens may also be formed as an acylindrical or also an aspherical cylinder, i.e. as a lens having a cylindrical surface whose cross-section deviates from the circular shape. Plano-concave and plano-convex acylinders can be used in the same way as those having a spherical or aspherical backside. Such an aspherical cylindrical lens can bundle incident light along a focus line without the influences of spherical aberration.

The “optical axis” of a fixation target having a cylindrical lens is an axis which is in parallel with a direction of electromagnetic beams which are generated in the focal line and are parallel after passing through the cylindrical lens (cf. also the propagation direction of the parallel light beams 50 shown in FIG. 3).

The term “substantially in parallel” describes electromagnetic radiation whose propagation direction is in particular parallel. That is, two electromagnetic beams are in parallel when their propagation directions are identical. This is particularly the case for electromagnetic radiation after passing through a cylindrical lens when a source of the electromagnetic radiation, in the focal plane, is arranged substantially in parallel with the focal line of the cylindrical lens, in particular in the focal line of a cylindrical lens. If sources of electromagnetic radiation are arranged in the focal line, the radiation is at the same time perpendicular to the lens plane.

Two electromagnetic beams may also be substantially in parallel even when their propagation directions enclose an angle with each other, wherein this angle is smaller than about 10°, more preferably smaller than about 5°, particularly preferably smaller than about 2°, particularly preferably smaller than about 10, particularly preferably smaller than about 0.25°, particularly preferably smaller than about 0.1°, very particularly preferably smaller than about 0.05°. If two electromagnetic beams pass the focal line of a cylindrical lens and the two electromagnetic beams are perpendicular to the focal line, they are substantially in parallel after passing through the cylindrical lens. If only one of the beams passes the focal line and the other beam does not pass the focal line, or if both beams do not pass the focal line and the two beams are perpendicular to the focal line, the two beams are substantially in parallel after passing through the cylindrical lens when the respective distance from the focal line is smaller than a prescribed value. This may be achieved, for example, by a light source not being arranged in the focal line, but by the light source being spaced apart from the focal line. Preferably, the distance of the light source from the focal line (or focal plane) is smaller than about 5%, preferably smaller than about 2%, preferably smaller than about 1%, preferably smaller than about 0.5%, preferably smaller than about 0.1% of the focal length of the cylindrical lens. Advantageously, the device thus preferably allows for a measurement accuracy of at least about ±0.2 mm, preferably of at least about ±0.05 mm, more preferably of at least about ±0.01 mm, for determining the pupillary distances. For a Gullstrand eye (radius 12 mm), this corresponds to an angular displacement of the eye of less than approx. ±1. This displacement is caused by an equally large deviation between the setpoint direction of the optical axis of the target and its actual direction. Thus, for the above-mentioned distance of the light source from the focal line, a deviation in the angular displacement of the eye of less than about 1° is preferably made possible.

The terms “electromagnetic radiation” and “light” may be used synonymously.

The term “substantially” may describe a slight deviation from a setpoint value, in particular a deviation within the scope of manufacturing accuracy and/or within the scope of necessary accuracy so that an effect as present at the setpoint value is maintained. The term “substantially” may therefore include a deviation of less than about 30%, less than about 20%, less than about 10%, less than about 5%, less than about 2%, preferably less than about 1% from a setpoint value and/or setpoint position, etc. The term “substantially” comprises the term “identical”, i.e. being without any deviation from a setpoint value, setpoint position, etc.

The term “light field” describes electromagnetic radiation which is radiated by a flat object. The flat object may, for example, be a constituent part of a fixation target. The flat object may be, for example, a curved surface of a cylindrical lens through which electromagnetic radiation exits the cylindrical lens. Although in this case the electromagnetic radiation exits through the curved surface, a spectacle wearer viewing the light field perceives the light field as being radiated by a planar, i.e. non-curved, flat object, for example. The light field may also be radiated by a surface of a diffuser which is, for example, rectangular. In other words, a “substantially rectangular light field” in its most general form describes a light field with a longitudinal extent and a width extent, wherein the longitudinal extent may, for example, be greater than the width extent. It is also possible for the light field to be substantially square, i.e. the longitudinal extent is approximately equal to the width extent. Consequently, the substantially rectangular light field may be the electromagnetic radiation radiated by a substantially rectangular surface, for example an at least partially translucent surface illuminated from behind. In particular, a substantially rectangular light field may be a light field whose projection onto a projection plane is substantially a rectangle, wherein the projection plane is perpendicular to the electromagnetic beams which are in parallel with one another, i.e. the projection plane is substantially perpendicular to the second plane (see below). The term “substantially rectangular” also includes deviations from the rectangular shape, e.g. with rounded corners, substantially elliptical, in particular with a ratio of the long half-axis to the short half-axis of more than 1:2. In order to avoid the spectacle wearer deviating from the habitual head and body posture with an elliptical target to view a target that is as long as possible, the target is preferably rectangular.

A “line” is not limited to a line in a mathematical sense. Rather, the term also comprises a two-dimensional object having a finite length and a finite width. A line may thus be a rectangle having a small width as compared to the length of the rectangle.

The term “homogeneous light”, in particular along a direction, describes that light with substantially the same light output and/or luminosity is radiated by the illumination unit, in particular along this direction. At all points of the illumination unit along this direction from which light is radiated, the radiated light has a similar, structure-free intensity. Here, the intensity may decrease towards the edges. When the radiated light is substantially homogeneous in this direction, the observer may not differentiate between individual light sources, but perceives a luminous line and/or, due to the finite extent of the illumination unit, a luminous strip and/or a luminous surface which radiates light of uniform intensity. This applies to a plurality of directions, in particular to a light radiation surface.

The term “habitual head and body posture” constitutes the basis for exact and compatible spectacle lens centering. In particular, the “habitual head and body posture” substantially corresponds to a head and body posture of the spectacle wearer that is as natural as possible. The spectacle wearer may adopt the “habitual head and body posture”, for example, when looking at themselves in the mirror since looking in the mirror is an everyday and very familiar situation for everyone. For example, a habitual head and body posture, as compared to a natural gaze into the distance, can be achieved when the subject fixates the root of their nose in the mirror image.

In particular, the habitual head and body posture may correspond to the natural posture of the spectacle wearer, which is determined by their physical and mental state, habits, everyday life, occupation and leisure time.

The spectacle wearer has a relaxed neck posture and a healthy, substantially ideal head posture in particular when the head is positioned exactly above the shoulders (and in the downward extension exactly above the arch of the foot). Thus, the habitual head and body posture is preferably adopted when standing.

With a substantially ideal head posture, the head sits substantially exactly above the shoulders (and in the downward extension exactly above the arch of the foot). The ears are perpendicular and are located above the middle of the shoulders. The neck is only slightly concave, i.e. curved inwards. In this position, the weight of the head is supported by the entire skeleton, i.e. the bones, via the spine. As the neck muscles do not need to support any weight, they are all soft and the head is freely movable on the spine. In all other head and/or neck postures, the neck muscles are chronically tense because then they have to hold the weight of the head against gravity. Depending on whether the head is pulled forwards or backwards or held to be inclined to the right or left, and whether the neck is more or less bent, different neck and body muscles are in constant contraction, i.e. different muscles are tense. This results in various types of head and neck pain. At the same time, the mobility of the neck is restricted since the muscles have to hold the head in a certain posture and are therefore only available for movement to a limited extent.

One aspect relates to a centering device for determining optical centering parameters of a spectacle wearer, comprising a fixation target which generates a flatly extended light field at a measurement location for illuminating at least one eye of the spectacle wearer. A measurement unit is configured to ascertain at least one measurement position of the at least one eye of the spectacle wearer when viewing the light field generated by the fixation target. A correction unit comprises deviation information about a deviation of the light field actually generated at the measurement location by the fixation target from a setpoint light field predetermined at the measurement location. The correction unit corrects the ascertained measurement position of the at least one eye when viewing the light field actually generated at the measurement location, taking into account the deviation information, to a setpoint position of the at least one eye which the at least one eye would prospectively adopt at the measurement location if it were to view the predetermined setpoint light field there. A parameter calculation unit ascertains, on the basis of the ascertained setpoint position of the at least one eye, at least one of the optical centering parameters to be determined.

The centering device may be configured as the centering device disclosed in document DE 10 2005 003 699 A1, for example. The centering device may be configured as a video centering system, for example. The centering device comprises at least the fixation target, the measurement unit, the correction unit and the parameter calculation unit. The centering device is designed and/or configured to determine optical centering parameters such as a pupillary distance, a corneal vertex distance and/or a face form angle, for example.

To this end, the centering device in particular has the measurement unit. The measurement unit may, for example, have at least two image capturing units for generating image data of the head of the spectacle wearer. The image capturing units may generate a stereo image of the head of the spectacle wearer, for example. Alternatively, the measurement unit may also have only one image capturing unit, e.g. in combination with an illumination unit such as a pattern projection unit, for example. Such a single-camera system, i.e. a centering device having only one image capturing unit, may be combined with a clip-on bracket, for example. A pattern projection unit can be dispensed with in this case. The measurement unit may in particular be configured to generate image data of the head of the spectacle wearer. The image data may comprise the head of the spectacle wearer and a spectacle frame. From the image data, the measurement unit may ascertain the measurement position of the at least one eye of the spectacle wearer. Preferably, the measurement unit ascertains the measurement positions of both eyes of the spectacle wearer.

The measurement unit may have further elements such as mirrors, lenses and/or gratings for deflecting the optical axes of the at least one image capturing unit. Furthermore, the measurement unit may have illumination means, a processor, a storage and/or a software implementation, for example.

When generating the image data, the spectacle wearer may be arranged approximately at a predetermined distance in front of the centering device. Here, the measurement position of the at least one eye may in particular comprise a measurement posture of the at least one eye. The measurement position may in particular comprise a measurement alignment of the at least one eye. When generating the image data, the spectacle wearer preferably adopts their posture of use, i.e. they wear the spectacle frame in a posture as natural as possible.

In order to control and/or align the gaze of the spectacle wearer when ascertaining the measurement position(s), the light field is radiated by the fixation target. The fixation target is thus designed and configured to generate the light field perceivable by the spectacle wearer in such a way that the gaze of the spectacle wearer is aligned. The light field may be configured as a substantially rectangular light field. The light field illuminates at least the one eye of the spectacle wearer, preferably at least both eyes of the spectacle wearer, particularly preferably the entire face of the spectacle wearer. The spectacle wearer may be instructed to look at the light field generated by the fixation target. Then, the light field of the fixation target influences and/or controls the measurement position and/or the measurement posture of the eye.

The fixation target may be configured in approximately the same way as the fixation target disclosed in document DE 10 2008 003 906 B4, for example. The fixation target may be formed by a vertical, diffusely luminous line and a vertically oriented cylindrical lens. The diffusely luminous line may be in the focal line of the cylindrical lens so that the resulting light field is configured to be in parallel with the propagation direction in the horizontal plane and diffuse in the vertical direction. Thereby, an eye can be displaced in the region of the light field in the horizontal direction in parallel with the propagation direction of the light field without being influenced in the vertical direction. If such a fixation target is used in the centering device, the propagation direction can be aligned such that the light field radiates from the centering device to the spectacle wearer.

In order to avoid erroneous displacement of the eye(s), the horizontal component of the direction of the light field may be configured to be uniformly parallel over the entire region. Otherwise, the eye would be displaced in a horizontal direction deviating from the direction of the light field, namely in the respective local direction of the light field at the location of the pupil.

As an alternative to the use of a fixation target having a line-shaped light source and a cylindrical lens, a fixation target having an approximately point-shaped light source and a spherical (or aspherically corrected) lens may be used. If the point-shaped light source is arranged in the focal point of this lens, the eye of the spectacle wearer can be deliberately displaced in two directions, that is, e.g. in the horizontal x direction and in the vertical y direction (cf. also FIG. 2). If the light source is arranged on the optical axis of the lens between the lens and its focal point, for example, the light field will be divergent as seen from the fixation target and the at least one eye of the spectacle wearer will be directed from this light field towards the optical axis of the fixation target. Depending on the position of the eye, this may be done equally symmetrically, e.g. in the horizontal x direction and in the vertical y direction (cf. also FIG. 2). If the light source is arranged outside the optical axis of the fixation target, an asymmetry is created, i.e. a deviation of the light field actually generated at the measurement location from the setpoint field of view predetermined at the measurement location, which may cause an erroneous displacement of the eye.

The fixation target illuminates at least the measurement location with its light field. Here, the measurement location describes the spatial region, illuminated by the light field of the fixation target, in which the centering device is to and/or can determine the measurement position and/or the optical centering parameters of the spectacle wearer. The light field does not have to be limited to the measurement location. At this measurement location, at least one eye of the spectacle wearer is arranged. The centering device is calibrated and/or aligned so as to be able to ascertain the measurement position of the at least one eye at the measurement location by means of the measurement unit.

In conventional centering devices, for example in the previously known centering device mentioned above, a parameter calculation unit ascertains the optical centering parameters directly from the measured measurement positions of the eyes. In the centering device according to the invention, however, the corrected setpoint position is used for this purpose rather than the measurement position ascertained by the measurement unit. This is appropriate in particular when the measurement position deviates from the setpoint position. This deviation may be caused, for example, by an inexpensively designed fixation target that does not generate its setpoint light field exactly, but rather a faulty light field. The fixation target may either be incorrectly calibrated relative to the centering device and/or damaged, and/or be of inferior quality. Such a faulty fixation target does not generate the predetermined setpoint light field at the measurement location, but the real light field deviating therefrom. If the actual measurement position and/or measurement posture of the eye is used for determining the optical centering parameters with a faulty fixation target, the centering parameters may be faulty.

According to the invention, this error is eliminated and/or avoided by the correction unit. In the correction unit, the deviation information is stored. The deviation information comprises information about the deviation of the light field actually generated by the fixation target at the measurement location from the setpoint light field predetermined there. The deviation information may comprise different deviation components in one dimension, in two dimensions or in three dimensions. The deviation information may be stored on a data carrier, in particular on a data carrier of the correction unit. The deviation information may be present as a function and/or in tabular form, for example.

The correction unit receives the measurement position of the at least one eye from the measurement unit. Here, the correction unit may also receive the measurement positions of both eyes. The corrections may be made monocularly, respectively, wherein the measurement positions of both eyes may be measured monocularly, respectively. When both eyes are to be measured, two fixation targets, e.g. with independent corrections, or alternatively a common fixation target may preferably be used. Due to the faulty fixation target, the eye posture in the measurement position is not adapted to the setpoint light field but to the faulty real light field. By means of the deviation information, the correction unit calculates the setpoint position and/or setpoint posture which the eye(s) would adopt if the fixation target were to generate the setpoint light field. To this end, the deviation information may in particular contain information about the actual light field generated.

The correction of the measurement position to the setpoint position and/or setpoint posture of the at least one eye may comprise a “virtual” eye movement, so to speak, namely an eye movement relative to the head and/or spectacle frame of the spectacle wearer. With this correction, the head posture and/or the alignment and positioning of the spectacle frame may in particular be left unchanged. Thus, only a correction of the setpoint position and/or setpoint posture of the at least one eye may be made, for example a pure correction of the rotational alignment and/or erroneous displacement of the at least one eye.

The correction unit may have a processor and/or may be software-implemented.

In other words, the correction unit allows to correct the error caused by a faulty fixation target when determining the optical centering parameters and to generate centering data with higher quality.

Here, the correction unit in particular allows to use fixation targets of poorer quality and/or lower cost since its faulty light field is excluded from the measurement data generated by the measurement unit by virtue of calculation by the correction unit. This can reduce the production costs of the centering device since components with a higher tolerance and/or standard components with assigned parameters can be used.

Furthermore, the centering device allows to shorten and/or simplify the elaborate adjustment of the fixation target relative to the measurement unit and/or the centering device since poor adjustment of the fixation target can also be corrected by the correction unit.

Advantageously, the spectacle wearer may be positioned as desired. The gaze of the spectacle wearer may be “automatically” aligned by the fixation target such that the gaze behavior does not have to be controlled by a person operating the device.

The spectacle wearer may at least partially fixate the light field. Thus, it is possible to align the gaze of a spectacle wearer based on the light field, e.g. for measuring purposes, such that the actual alignment of the pupils corresponds to a defined, prescribed gaze behavior. Particularly advantageously, the gaze direction and/or the pupil position of the pupil(s) of the spectacle wearer may be determined in the habitual head and body posture. Advantageously, the use of the light field allows the spectacle wearer to adopt their habitual head and body posture when fitting a progressive lens since the spectacle wearer is only slightly restricted in their head posture, namely by the extent of the light field, in contrast to the use of a point-shaped fixation target (such as a luminous dot, for example).

Thus, it is possible for the spectacle wearer to view the light field and thereby adopt their preferred, particularly natural, head posture. This is not possible when using a fixation point in the form of a light point since a light point restricts the gaze direction in all directions. Rather, in this case the head posture is substantially prescribed by the fixation point in the form of a light point, wherein erroneous positioning of the fixation point in the form of a light point inevitably causes misalignment of the subject's gaze behavior.

In contrast to a point-shaped fixation target, the described shape of the light field allows for greater freedom, in particular when setting the gaze direction of the spectacle wearer relative to the device, preferably with the habitual head and body posture of the spectacle wearer.

The fixation target can still be sufficiently recognized in the case of defective and/or poor vision of the spectacle wearer so that the spectacle wearer can view the light field of the fixation target. The light field may possibly appear wider than it is, however, this is negligible as long as the spectacle wearer can view the light field. This is often not possible when using a fixation point. Particularly advantageously, the light field is designed so as to be still sufficiently recognizable even when the spectacle wearer is not wearing corrective spectacles. This can be achieved by a sufficient luminosity of the light field and/or color of the light of the light field.

The fixation target may be arranged and/or designed in such a way that the spectacle wearer is positionable such that at least one pupil of the spectacle wearer is substantially completely illuminated, i.e. that this pupil is located substantially completely in the light field of the fixation target. This may also apply to the second pupil and possibly a further fixation target.

According to one embodiment, the fixation target is configured in such a way that the electromagnetic radiation of the light field is configured to be substantially diffuse in a first predeterminable plane and the electromagnetic radiation of the light field is configured to be substantially parallel in a second predeterminable plane which is arranged approximately perpendicular to the first plane. In other words, the optical path may be parallel in one direction and diffuse in the direction perpendicular thereto. This gives the spectacle wearer the impression of a luminous surface, for example in the form of a luminous strip, in particular a luminous line in the direction of the diffuse radiation. The extent of the light field may be larger than the strip perceived by the spectacle wearer, however, the substantially parallel radiation gives the spectacle wearer the visual impression of a strip. Preferably, the light field is configured to be significantly wider than the pupil of the spectacle wearer, i.e. at least 2 times, 5 times, 10 times and/or 20 times as wide as the pupil of the spectacle wearer. A width of about 32 mm has proven to be particularly suitable. Thus, the spectacle wearer can shift their position without their visual impression being changed as long as they are in the light field of the fixation target and see the light in parallel in the second plane. In other words, the visible strip “moves along” with the shift of the spectacle wearer.

Due to the configuration of the light field, the gaze direction of the spectacle wearer when viewing the light field is prescribed by the direction of the light field, i.e. by the direction of the parallel beams. For example, if the first plane is a vertical plane in the Earth's reference system and the second plane is a horizontal plane in the Earth's reference system, the gaze direction of the spectacle wearer in the horizontal direction is prescribed by the direction of the light of the light field. In the vertical direction, the gaze direction is limited by the vertical extent. Thus, the spectacle wearer can adopt their natural gaze posture within the light field.

In addition to the above explanations, the spectacle wearer will direct their gaze “to infinity” when viewing the light field of the fixation target due to the parallel electromagnetic beams. In other words, the spectacle wearer perceives the light field as being “infinitely” distant due to the parallel electromagnetic beams of the light field. Thus, the spectacle wearer adopts a natural head and body posture which corresponds to natural vision into the distance, in particular straight out into the distance. Advantageously, the visual impression of the spectacle wearer is substantially independent of the exact position of the eye in front of the fixation target, in particular in front of the light field, as long as the spectacle wearer is viewing the parallel electromagnetic radiation. For example, the spectacle wearer can shift their position in a direction in parallel with the second plane, for example in the horizontal direction, as long as they are viewing the parallel electromagnetic radiation of the light field. In the vertical direction, the spectacle wearer is free to move their head due to the diffuse electromagnetic radiation, i.e. the spectacle wearer can move their head freely in the vertical direction when the first plane is a vertical plane, for example, and adopt their natural head posture. Thus, the gaze direction is only prescribed in one spatial direction, namely the horizontal direction, due to the direction of the parallel light. If the light field is wide, the spectacle wearer can slightly turn and/or shift their head if necessary, wherein the visible strip “moves along” when shifting the head horizontally. If the light field is narrow in a first (e.g. horizontal) direction, the spectacle wearer is substantially limited to the narrow light field in their head posture of this first direction. If the light field is relatively extensive in a second (e.g. vertical) direction, the spectacle wearer is relatively free to choose their gaze direction in this second, e.g. vertical, direction. In the first (e.g. horizontal) direction, the spectacle wearer thus cannot freely choose their gaze direction since they only recognize the strip when they align their gaze direction in parallel with the beams (and thus with the optical axis of the fixation target). Thus, they cannot look to the right or left (away from the first direction) as desired but can only select the exact position of the eye (corresponding to the measurement position) within the light field (i.e. at the measurement location). In the second (e.g. vertical) direction, the light field diffusely radiates so that the spectacle wearer can look in any direction in this second direction. They can thus look (e.g. vertically) upwards and/or downwards, even outside the light field. This can be advantageous especially when fitting progressive lenses.

According to one embodiment, the deviation information comprises a deviation of the light field generated at the measurement location from the setpoint light field predetermined at the measurement location in at least one of the following components:
a deviation in a prismatic component;
a deviation in a defocus component; and/or
a deviation in a higher order component;
   wherein each of this at least one component is configured to be height-dependent or height-independent.

In the event that the fixation target has a cylindrical lens and a luminous line as a light source, there may be a deviation in a prismatic component. Such a deviation may result from the fact that the luminous line is arranged in the focal plane and in parallel with the cylinder axis of the cylindrical lens, but there is a lateral offset between the focal line of the cylindrical lens and the luminous line. This may be caused, for example, by a tolerance of the cylindrical lens with respect to the lateral position of the focal line. In this case, the horizontal component of the direction of the light field can be assumed to be still in parallel but tilted in the horizontal plane with respect to the optical axis of the fixation target. Here, the optical axis of the fixation target may be an axis arranged substantially horizontal and perpendicular to the cylinder axis of the cylindrical lens. This deviation may be described by means of a tilt angle and/or an equivalent parameter and be available as deviation information. A dependency on the position in space is not required here, neither for the description nor in the evaluation.

In the event that the luminous line is arranged in parallel with and without any lateral offset from the cylinder axis of the cylindrical lens, there may be an axial distance to the focal plane. This may be caused, for example, by a tolerance of the cylindrical lens with respect to the focal length. In this case, the horizontal component of the direction of the light field is impaired a defocus proportion. It is thus convergent and/or divergent. For describing this deviation, a location-independent parameter which specifies the degree of divergence and/or convergence is sufficient. This may be, for example, the position of the line where all the beam planes of the light field intersect, i.e. the distance of this line from a defined horizontal plane perpendicular to the optical axis of the fixation target, for example. Even when no location-dependent parameters are necessary for the description here, the local direction of the horizontal component of the direction of the light field at the location of the pupil and/or the eye should be determined for the evaluation in this case.

Due to the shape of the lens and/or a deviation in the position of the luminous line from the position of the focal line, the horizontal component of the direction of the light field may also have higher order components in addition to a prismatic and/or a defocus component. An example of this is the spherical aberration of a lens having spherical surfaces. For describing the horizontal component of the direction of the light field, one or more location-independent parameter(s) may be used accordingly, which specifies or specify the properties of the horizontal component of the direction of the light field in suitable notation. Examples of this are Zernike coefficients, Taylor coefficients and Seidel's eikonals. In this case as well, the local direction of the horizontal component of the direction of the light field at the location of the eye and/or the pupil should be determined for the evaluation.

The different components may occur in combination. For example, a prismatic component may be combined with a defocus component by shifting the diffuse luminous line from the focal line in the horizontal direction perpendicular to the optical axis of the fixation target and along the optical axis of the fixation target. In this case as well, the light field may be specified by the position of the line, i.e. its position perpendicular to the optical axis of the fixation target and/or in the direction of the optical axis of the fixation target where all beam planes of the light field intersect. In this case, one or more location-independent parameters may also be used for describing the horizontal component of the direction of the light field, which specify the properties of the horizontal component of the direction of the light field in suitable notation.

Examples of this are Zernike coefficients, Taylor coefficients and Seidel's eikonals. In this case as well, the local direction of the horizontal component of the direction of the light field at the location of the pupil should be determined for the evaluation.

In the deviations described above, it has been assumed that the light field is independent of the height, i.e. the vertical direction, and is thus translation-symmetrical in the direction of the focal line. However, this is not always the case. The luminous line may be configured and/or arranged to be bent or to be tilted with respect to the focal line, or the lens may be ground asymmetrically.

In this case, the above explanations apply analogously, taking into account the respective height. Here, the components may be described and/or specified for different heights on a plane-by-plane basis. Alternatively, they may be specified in the form of global components and/or the three-dimensional position of the line of the points where the beams intersect in a plane, respectively. Here, the height is added as a third coordinate.

According to one embodiment, the deviation information comprises a description of the light field generated at the measurement location as a location-dependent function and/or as a location-dependent value table at reference positions. The deviation information may describe the local direction of the light field as a function of the location in space, for example as an angle and/or as the direction of a vector. This function may be specified analytically and/or adapted to existing information about the light field, for example as a power series approach. If the shape of the light field does not lend itself to an analytical description and/or if such a description is not necessary or not desired, a value table may be specified for each (or at least a plurality of) reference points in space. The reference points may be arranged along the direction of the light field. For example, angles and/or directions of a vector may be specified as values of the value table. Here, it is possible to interpolate between reference points.

According to a further development of this embodiment, the location-dependent function and/or the location-dependent value table specifies at least one angle of the generated light field and/or at least one direction vector of the generated light field. The angle may specify a deviation of the propagation direction of the really existing light field from the setpoint light field. The angle may in particular be configured as a horizontal angle. If the direction vector of the really generated light field is known, the deviation information may contain the deviation of this direction vector from the desired direction vector of the setpoint light field at the respective location, e.g. as a tilt angle with respect to the setpoint light field.

According to one embodiment, the ascertained measurement position of the at least one eye when viewing the light field actually generated at the measurement location comprises an erroneous displacement of the at least one eye, which comprises a horizontally aligned erroneous displacement angle. This erroneous displacement may result from the fact that the light field actually generated at the eye position deviates from the desired setpoint light field. Consequently, the ascertained measurement position, which is ascertained by the measurement unit, also deviates from the desired setpoint position. This deviation may correspond to the erroneous displacement angle and/or tilt angle, at least in the horizontal plane. Here, the head posture and/or spectacle frame posture may remain unchanged, for example.

According to one embodiment, the correction unit corrects the ascertained measurement position of the at least one eye taking into account an eye radius in one or in two or in three dimension(s). The eye radius may, for example, be assumed to be generic, as described, for example, in DIN e.V.: DIN EN ISO 5340, “Begriffe der physiologischen Optik” (“Terms in physiological optics”), April 1998, or in C. W. Oyster: “The Human Eye”, 1999. The eye radius may also be estimated from other parameters of the eye, for example from a visual defect, specifically according to a linear relationship which is specified, for example, in C. W. Oyster: “The Human Eye”, 1999. Alternatively, the eye radius may also be measured in another way, as specified, for example, in S. Trumm et al.: “Helligkeitsabhangige Anpassung eines Brillenglases” (“Brightness-dependent fitting of a spectacle lens”), DE 10 2011 120 974 A1, or in S. Trumm et al.: “Belegung eines Augenmodells zur Optimierung von Brillenglasern mit Messdaten” (“Assignment of an eye model for optimizing spectacle lenses with measurement data”), DE 10 2017 007 975 A1. Depending on the eye radius thus used, the displacement of the eye posture and/or the eye position in the image data captured by the measurement unit may be calculated from geometric considerations. If a correction is made in only one dimension here, in particular the displacement of the measurement position in the horizontal direction may be corrected, e.g. horizontally and approximately perpendicular to the optical axis of the fixation target, cf. x direction in FIGS. 3 and 5. Here as well, the head posture and/or spectacle frame posture may remain unchanged, for example.

In a further development of this embodiment, the correction unit ascertains the eye radius from data acquired by the measurement unit and uses this eye radius thus ascertained when correcting the measurement position of the at least one eye. Here, the correction unit is thus also designed and configured to ascertain the eye radius from the data generated by the measurement unit. By virtue of this ascertainment of the actual eye radius, the accuracy of the centering device can be further increased.

According to one embodiment, the measurement position and/or the setpoint position of the at least one eye comprises a pupil position, a corneal vertex position and/or an ocular center of rotation. As already mentioned above, the measurement position may be specified as a measurement posture and/or the setpoint position may be specified as a setpoint posture of the eye. Here, the pupil position and/or the corneal vertex position may be specified in three-dimensional coordinates. Alternatively, this position may also be specified only two-dimensionally, for example two-dimensionally in the image data captured by the measurement unit. Likewise, the ocular center of rotation may also be specified two- or three-dimensionally. In addition to the ocular center of rotation, an eye alignment may be used, for example a vectorially specified gaze direction of the at least one eye. From this setpoint position thus specified, several optical centering parameters may be calculated by the parameter calculation unit.

According to one embodiment, the parameter determination unit ascertains at least one of the following parameters as an optical centering parameter and/or as an individual parameter from the setpoint position:
a monocular pupillary distance;
a fitting height;
a binocular pupillary distance;
a corneal vertex distance;
a forward inclination in the posture of use, and/or
a face form angle in the posture of use.

The definitions of these centering parameters and these individual parameters (such as the forward inclination in the posture of use and the face form angle in the posture of use) can be found in the relevant standards and/or specialist literature, for example the publications mentioned above. Here, in particular the centering parameters listed above are dependent on the eye position, i.e. on the setpoint position which may deviate from the measurement position.

For this reason, the invention in particular allows to ascertain the centering parameters listed above particularly accurately. Preferably, several or even all of the centering parameters listed above are ascertained taking into account the setpoint position.

One aspect relates to a method for determining optical centering parameters of a spectacle wearer, comprising the steps of:
generating a flatly extended light field at a measurement location for illuminating at least one eye of the spectacle wearer by means of a fixation target;
ascertaining at least one measurement position of the at least one eye of the spectacle wearer when viewing the light field generated by the fixation target;
providing deviation information about a deviation of the light field actually generated at the measurement location by the fixation target from a setpoint light field predetermined at the measurement location;
correcting the ascertained measurement position of the at least one eye when viewing the light field actually generated at the measurement location, taking into account the deviation information, to a setpoint position of the at least one eye which the at least one eye would prospectively adopt at the measurement location if it were to view the predetermined setpoint light field there; and
calculating, on the basis of the ascertained setpoint position of the at least one eye, at least one of the optical centering parameters to be determined.

The method may in particular be performed by means of the centering device according to the aspect described above. Therefore, the explanations regarding the centering device also relate to the method and vice versa.

According to one embodiment, the light field generated at the measurement location by the fixation target is measured by means of a light field measurement device to provide the deviation information. This measurement of the light field may replace and/or supplement an exact calibration of the fixation target. By measuring the light field actually generated at the measurement location, the difference of this actually generated light field from the setpoint light field may be ascertained. This difference may be stored and/or saved as deviation information in the correction unit. The measurement of the light field may be carried out once when setting up the centering device. The measurement of the light field may also be repeated by specialist personnel during regular maintenance of the centering device, for example, to update the deviation information in this way.

In a further development of this embodiment, the light field measurement device has at least one diaphragm and/or one imaging optics and/or one measurement camera, for example a measurement camera without any diaphragm. In this way, the light field measurement device may be configured similarly to a pinhole camera having at least one diaphragm, for example. Alternatively or additionally, the light field measurement device may also have imaging optics such as a lens and/or a combination of a lens and a diaphragm, for example.

According to one embodiment, the light field measurement device is aligned relative to the fixation target and/or to components of the fixation target in a controlled manner prior to measurement of the light field generated at the measurement location. By virtue of the controlled alignment, it is possible to specify in which position and/or in which alignment the light field measurement device is arranged relative to the centering device and/or the fixation target.

According to one embodiment, light-influencing components of the fixation target are measured and contributions to the light field generated at the measurement location which are generated by said components are estimated. This estimation may comprise ascertaining and/or calculating. The contributions of the components are incorporated into the deviation information and/or are used as the deviation information. This may be done as an alternative to the measurement of the light field generated by the fixation target. The light-influencing components of the fixation target may comprise, for example, at least one lens and/or at least one light source and/or a spatial arrangement of the light source relative to the lens, in particular their distance from one another. The contributions to the light field which are generated by the components may thus be estimated and used as deviation information. Here, individual samples from a batch of light-influencing components may be measured, for example, and a conclusion may be drawn from these samples to the contribution of the light-influencing components of this batch. Thereby, it is not absolutely necessary to individually measure all light-influencing components, and the measurement effort can be reduced.

According to one embodiment, at least one contribution of at least one light-influencing component of the fixation target to the deviation information is previously known and is incorporated into the deviation information without being measured and/or said at least one contribution is used as the deviation information without being measured. This may be the case in particular when certain lens shapes such as, for example, lens radii of the lens body can be produced more simply and/or cheaply with prescribed and/or existing tools. In this case, the lens body thus deviating from the ideal setpoint shape may be deliberately produced, and the previously known contribution to the deviation information may be taken into account. Here, a measurement of this previously known contribution to the deviation information can be dispensed with so that this light-influencing component can be used without being measured.

One aspect relates to a use of a centering device according to the first aspect for performing the method according to the second aspect.

Terms such as up, down, above, below, lateral, etc. refer to the Earth's reference system in an operating position of the subject-matter of the invention, unless otherwise specified.

### BRIEF DESCRIPTION OF THE DRAWINGS

In the following, the invention is described in more detail based on exemplary embodiments shown in figures. Here, the same or similar reference signs may denote the same or similar features of the embodiments. Individual features shown in the figures may be implemented in other exemplary embodiments. Shown are:

FIG. 1 in a perspective and schematic illustration, a centering device measuring a spectacle wearer;

FIG. 2 in a perspective and schematic illustration, a fixation target of a centering device;

FIG. 3 in a schematic plan view, a fixation target of a centering device;

FIG. 4A in a perspective view, a schematic illustration of a first light field measurement device having slit-shaped, vertical diaphragm openings;

FIG. 4B in a front view, a schematic illustration of a second light field measurement device having multiple diaphragm openings; and

FIG. 5 in a schematic illustration, an eye position of a spectacle wearer.

### DETAILED DESCRIPTION

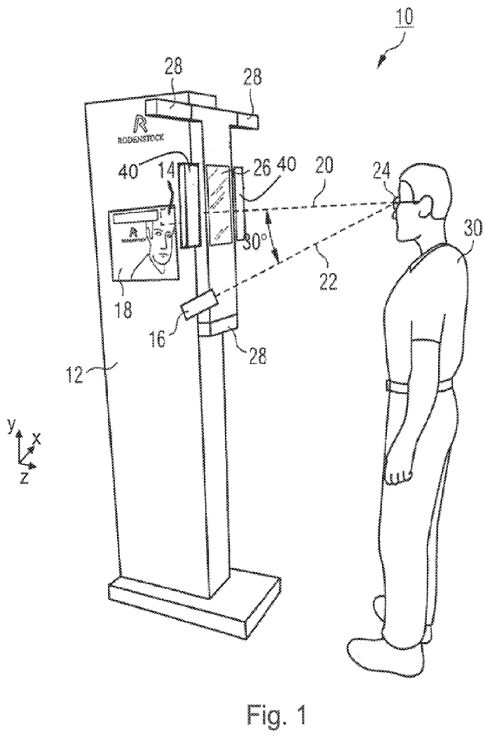

FIG. 1 shows a schematic perspective view of a centering device 10 for determining optical centering parameters of a spectacle wearer 30. The centering device 10 has an arrangement unit in the form of a housing and/or a column 12 on which a first image capturing unit 14 in the form of an upper camera and a second image capturing unit 16 in the form of a lateral camera is arranged. Further, a data output unit in the form of a monitor 18 is integrated into the column 12.

The upper camera 14 is preferably located inside the column 12, as shown in FIG. 1, for example, at least partially at the same level as the monitor 18. In the operating posture, the upper camera 14 and the lateral camera 16 are arranged so as to be able to generate image data of the head of the spectacle wearer 30. Here, an effective optical axis 20 of the upper camera 14 and an effective optical axis 22 of the lateral camera 16 may intersect one another in an intersection 24. The intersection 24 of the effective optical axes 20, 22 is preferably the point of a nose root or the center point of the bridge.

The upper camera 14 may be arranged centrally behind a semitransparent mirror 26. The image data of the upper camera 14 are generated through the semitransparent mirror 26. The image data (hereinafter referred to as images) of the upper camera 14 and the lateral camera 16 are preferably output at the monitor 18.

Furthermore, at the column 12 of the centering device 10, (e.g. three) illumination means 28 may be arranged. The illumination means 28 may be, for example, glow sticks such as fluorescent tubes. However, the illumination means 28 may also each have one or more light bulbs, halogen lamps, light-emitting diodes, etc.

The effective optical axis 20 of the upper camera 14 may be arranged in parallel with the zero direction of sight of the spectacle wearer 30, for example. The zero direction of sight corresponds to the fixating line of the eyes of the spectacle wearer 30 in the primary posture. The lateral camera 16 may be arranged in such a way that the effective optical axis 22 of the lateral camera 16 intersects the effective optical axis 20 of the upper camera 14 in an intersection 24 at an intersection angle of approximately 30°, for example. The intersection 24 of the effective optical axes 20, 22 is preferably the point of a nose root of the spectacle wearer 30. Here, other intersection angles are possible as well, e.g. the intersection angle may be configured to be smaller than about 60°. It is not necessary for the effective optical axes 20, 22 to intersect.

The cameras 14, 16 may be adapted to generate individual images of a partial region of the head of the spectacle wearer 30, respectively. It is also possible to capture video sequences by means of the cameras 14, 16 and use these video sequences for further evaluation. The image data and/or images may be captured in a time synchronized manner for further evaluation.

In the operating posture, the spectacle wearer 30 may be arranged and/or positioned in such a way that their gaze is directed to the semitransparent mirror 26, wherein the user looks at approximately the image of the root of their nose in the mirror image of the semitransparent mirror 26.

The image capturing units 14, 16 may be elements of a measurement unit of the centering device 10. Further elements of the measurement unit may be arranged inside the housing 12, for example, such as a processor, a storage and/or a software, for example. By means of the image data captured by the image capturing units 14, 15, the measurement unit may ascertain the measurement position of at least one eye of the spectacle wearer 30, preferably the measurement positions of both eyes of the spectacle wearer 30.

The centering device 10 further has at least one fixation target 40. Here, the centering device 10 may also have two fixation targets 40, e.g. for aligning the spectacle wearer 30 in different positions.

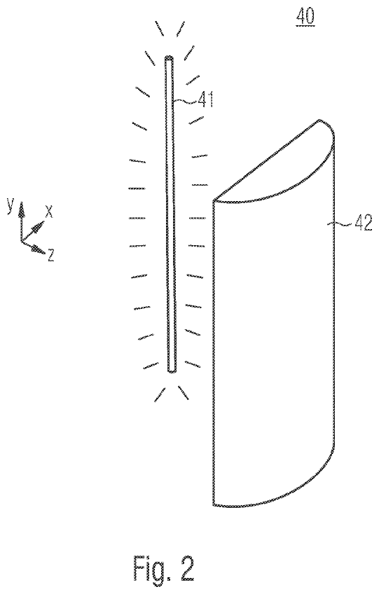

FIG. 2 shows a schematic, perspective view of an embodiment of a fixation target 40. The fixation target 40 has a cylindrical lens 42 and a light source 41. The light source 41 may comprise an LED, for example, in particular a homogeneous LED, an incandescent light bulb or a similar light source. The light source 41 may be arranged approximately at a focal line of the cylindrical lens 42.

In the embodiment shown, the light source 41 is configured to be approximately rod-shaped and/or cylinder-shaped. The light source 41 may thus be substantially configured as a luminous line. The rod-shaped light source 41 is approximately vertically arranged, i.e. the cylinder axis of the light source 41 is approximately vertically arranged. In the figures, the vertical direction is denoted as a y direction of a Cartesian coordinate system.

The cylinder axis of the cylindrical lens 42 is also approximately arranged vertically, i.e. in the y direction. The light source 41 is spaced apart from the cylindrical lens 42 in the negative z direction. Here, the z direction is an approximately horizontally aligned direction which points away from the convex side of the cylindrical lens 42 approximately perpendicularly in the direction of the light field radiated by the light source 41 through the cylindrical lens 42.

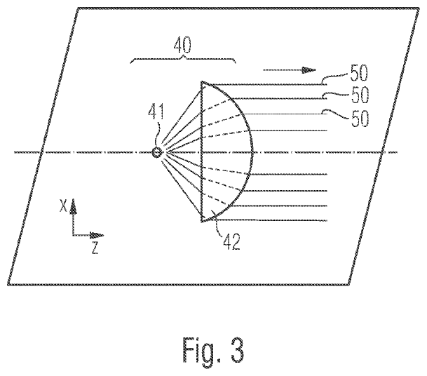

FIG. 3 shows the fixation target 40 in a schematic plan view. Here, it is shown how the light radiated from the light source 41 illuminates the approximately flat backside of the cylindrical lens 42. This light penetrates the cylindrical lens 42 and is radiated from the cylindrical lens 42 at its convex side facing away from the light source 41 as light beams 50 aligned approximately in parallel. The light beams 50 form the light field actually generated and/or radiated by the fixation target 40.

The light beams 50 are aligned approximately in parallel with one another and radiate approximately in the z direction, i.e. approximately horizontally away from the fixation target 40 (and the centering device 10) towards the spectacle wearer 30 (cf. also the coordinate system shown in FIG. 1). The z direction thus coincides with the optical axis of the fixation target.

Ideally, the light source 41 is arranged exactly in the focal line of the cylindrical lens 42. Then, the electromagnetic radiation provided by the light beams 50 is exactly parallel. If the cylinder axis and the focal line of the cylindrical lens 42 are exactly vertically arranged, the light beams 50 also propagate exactly in a horizontal plane in the Earth's reference system. Such an x-z plane is shown in FIG. 3, for example.

The x direction of the coordinate system used is also approximately horizontally arranged, is perpendicular on the y and z directions and points away from the fixation target 40 in a lateral direction (cf. FIG. 2). The x direction may be arranged in parallel with the flat backside of the cylindrical lens 42 and/or point in a lateral direction, for example.

An optical axis of the fixation target 40 is an axis which is arranged substantially in parallel with the electromagnetic radiation of the light beams 50. The optical axis of the fixation target thus points in the z direction.

The light field of the fixation target 40 is formed by the vertical, diffusely luminous light source 41 and the vertically oriented cylindrical lens 42. Since the diffusely luminous light source 41 is in the focal line, the resulting light field (cf. FIG. 3) is in parallel with the axis of the fixation target 40, that is, the z direction, along the x direction in the horizontal plane (x-z plane) and diffuse in the vertical y direction. Thereby, an eye is displaced in the region of the light field when viewed horizontally in parallel with the axis of the fixation target but is not vertically influenced.

Here, the focal line does not have to be outside the lens element of the cylindrical lens 42 (as shown in FIGS. 2 and 3). In a monolithic design, the focal line, and thus the luminous line, may also be at the back surface of or within the lens element.

If this fixation target 42 is used in the centering device 10 and/or a video centering system, the axis of the fixation target (z axis) may be aligned in parallel with the axis of the centering device 10. This axis of the centering device 10 may, for example, be the effective optical axis of one of the image capturing units, e.g. the first effective optical axis 20 of the first image capturing unit 14. In general, the axis of the fixation target 40 may be arranged in parallel with the effective optical axis of a centering device having only one camera, in parallel with a primary camera of a centering device having two or more cameras, or an axis of symmetry in a centering device having multiple cameras arranged laterally relative to one another. In a centering device which has a mirror 26 in which the spectacle wearer 30 can observe themselves, the axis of the centering device may also be defined depending on the alignment of the mirror surface (typically as a normal to the mirror surface).

In order to avoid erroneous displacement of the eyes of the spectacle wearer 30, the horizontal component of the direction of the light field should be arranged consistently in parallel and in parallel with the axis of the centering device 10 over the entire region. Otherwise, the eye would be displaced in the horizontal in a manner deviating from this setpoint direction, namely in the respective local direction of the light field at the location of the pupil of the spectacle wearer 30.

In order to make such a light field available, two conditions have to be satisfied in conventional fixation targets: Firstly, the cylindrical lens 42 must not have any imaging errors, which places high demands on its production. Secondly, the diffusely luminous light source 41 must be exactly in the focal line of the cylindrical lens 42. This requires an adjustable system and/or precisely fitting components. The adjustable system requires complex optics and mechanics which allow for adjustment of both optical elements 41, 42 relative to one another and to the axis of the centering device 10. Furthermore, elaborate adjustment during and/or after production is required for this. The precisely fitting components should have tolerances so low and corresponding fits that when assembling the components, a light field having the necessary quality is necessarily formed due to the tolerance chain. This places particularly high demands on the production of the cylindrical lens 42. The tolerances, necessary therefor, for the lateral and axial positions of the focal line in relation to the surface elements of the cylindrical lens 42 cannot be achieved with inexpensive standard processes.

This is true in particular for light fields having a large lateral extent (in particular in the x direction) since in this case, imaging errors of a lens (in particular with simpler cylindrical lenses having a spherical cross-section) have a particularly significant impact. Certainly, lenses having aspherical cross-sections, which are to be manufactured with high effort, are required to avoid the imaging errors.

It may be an object of the invention to provide devices and methods which allow for high accuracy in measuring parameters, in particular optical centering parameters, of the eye and/or the spectacle-eye system with less complex components and/or systems at low manufacturing costs. Examples of such parameters are the known centering and individual parameters as well as the position of the ocular center of rotation, the position, shape and size of the pupil as well as the position of the corneal vertex.

In order to reduce the costs mentioned above, a low-quality light field may be used, for example with components which are not exactly adjusted and/or with lenses which are not exactly produced. A correction of the ascertained optical centering parameters of the at least one eye or the spectacle-eye system is made using the properties of the light field, in particular deviation information.

To this end, the actually generated light field of the fixation target 40 may first be characterized. Subsequently, on the basis of at least one directly ascertained measurement position of the elements of the eye and/or the spectacle-eye system, at least one optical centering parameter to be determined may be determined taking into account the deviation information and/or the actually generated light field.

### Description of the Light Field

In the following, several possibilities of how to describe the light field generated by the fixation target 40 shown in FIGS. 2 and 3 are described. These descriptions may form part of the deviation information which may be stored in the correction unit.

In general, however, fixation targets may not have exactly one rod-shaped light source 41 and one cylindrical lens 42, but they may also have multiple light sources and other and/or multiple lenses. Such differently shaped fixation targets may be described in an analogous and/or similar way.

Ideally, the light source 41 should be arranged exactly in the focal line of the cylindrical lens 42, the cylindrical lens should not have any lens defects, and the fixation target should be exactly aligned with the centering device so that an ideal setpoint light field is generated. The setpoint light field may, for example, form diffuse radiation in a first predeterminable plane, in particular in the vertical. The electromagnetic radiation of the setpoint light field may be formed in parallel in a second predeterminable plane which is arranged perpendicular to the first plane. This may be the horizontal plane.

In practice, however, the actually emitted and/or generated light field may deviate from the desired setpoint light field, in particular when using cheap elements of the fixation target and/or in simple adjustment of the fixation target at the centering device.

If the light sources 41 are arranged in the focal plane and in parallel with the cylinder axis of the cylindrical lens 42, for example, there may be a lateral offset between the focal line of the lens and the rod-shaped light source 41. This may be caused by a tolerance of the lens with respect to the lateral position of the focal line, for example.

In this case, the horizontal component of the direction of the light field may be assumed to be still in parallel but tilted in the horizontal plane with respect to the z axis. Here, the light field and/or the deviation information may thus have a prismatic component.

As a description of such a prismatic component, a horizontal tilt angle (or an equivalent parameter) may be sufficient. A dependency on the position in space is not required here, neither for the description nor in the evaluation.

In the event that the rod-shaped light source is in parallel with and without any lateral offset from the cylinder axis, an axial distance to the focal plane may occur. This may be caused by a tolerance of the cylinder axis 42 with respect to the focal length, for example.

In this case, the horizontal component of the direction of the light field is imparted a defocus proportion. It is convergent or divergent. Here, the light field and/or the deviation information may thus have a defocus component.

For describing such a light field, a location-independent parameter which specifies the degree of divergence and/or convergence may be sufficient. This may be the position of the crossing line where all the beam planes of the light field cross one another, for example. This may be, for example, a distance of this crossing line from a defined vertical plane such as the x-y plane, for example.

Even when location-dependent parameters are not necessary for the description here, in this case, the local direction of the horizontal component of the direction of the light field at the measurement location, in particular at the location of the pupil of the spectacle wearer 30, may be determined for the evaluation.

By virtue of the shape of the lens and/or a deviation in the position of the luminous line from the position of the focal line, the horizontal component of the direction of the light field may also have higher order components in addition to a prismatic and/or a defocus component. An example for this is the spherical aberration of a lens having spherical surfaces. Here, the light field and/or the deviation information may thus have higher order components.

Accordingly, for describing the horizontal component of the direction of such a light field, one or more location-independent parameters may be used which specify properties of the horizontal component of the direction of the light field in a suitable notation. Examples for this are Zernike coefficients, Taylor coefficients and Seidel's eikonals.

In this case as well, the horizontal component of the direction of the light field at the measurement location, in particular at the location of the pupil of the spectacle wearer 30, should be determined for the evaluation.

Various components of the ones stated above may occur in combination. For example, by shifting the diffusely luminous line from the focal line in the x and z directions, a prismatic component may be combined with a defocus component. In this case as well, the light field may be specified by the position (position in the x and z directions) of the crossing line where all beam planes of the light field cross one another.

Analogously to the procedure described above, multiple location-independent parameters which specify properties of the horizontal component of the direction of the light field in suitable notation may also be used here for describing the horizontal component of the direction of the light field. Examples for this are Zernike coefficients, Taylor coefficients and Seidel's eikonals.

In this case as well, the local direction of the horizontal component of the direction of the light field at the measurement location, in particular at the location of the pupil of the spectacle wearer 30, may be determined for the evaluation.

The deviation information may be stored as a location-dependent function and/or location-dependent table. In this way, the local direction of the light field can be described as a function of the location in space, e.g. as an angle and/or as a direction of a vector. This location-dependent function may be given analytically, and/or be adapted to existing information about the light field as a power series approach, for example.

If the shape of the light field does not lend itself to an analytical description or it is not necessary or not desired, the local direction of the light field may be specified for each point in space, e.g. as an angle and/or as a direction of a vector. Here, it is also possible to interpolate between reference locations.

The light field may be described in a height-dependent manner. In the above, it has been assumed that the light field is arranged independently of the height, i.e. the y coordinate, and thus translation-symmetrically in the direction of the focal line of the cylindrical lens 42. However, the actually generated light field may also be configured height-dependently, i.e. have a height-dependent component.

In this way, the rod-shaped light source 41 may be bent and/or tilted with respect to the focal line. Furthermore, the cylindrical lens 42 may be ground asymmetrically. In this case, the above explanations analogously apply while additionally taking into account the y coordinate.

In description with a prismatic component, a defocus component, with higher order components and/or combinations thereof, these components may be specified for different heights on a plane-by-plane basis. Alternatively or additionally, they may be specified in the form of global components and/or a three-dimensional position of a line of the intersections where the light beams of one (e.g. horizontal) plane, respectively, intersect one another. In the case of a height-dependent light field, the height may be added as a third coordinate, i.e. the y coordinate.

### Characterization of the Light Field

In the following, several possibilities of how to obtain and/or acquire the deviation information about the light field generated by the fixation target 40 shown in FIGS. 2 and 3 are described.

In order to obtain the deviation information about the light field, there are the following possibilities, for example:

The actually emitted light field may be measured. This may be done by means of a light field measurement device, for example.

In some embodiments, the light field measurement device has a diaphragm.

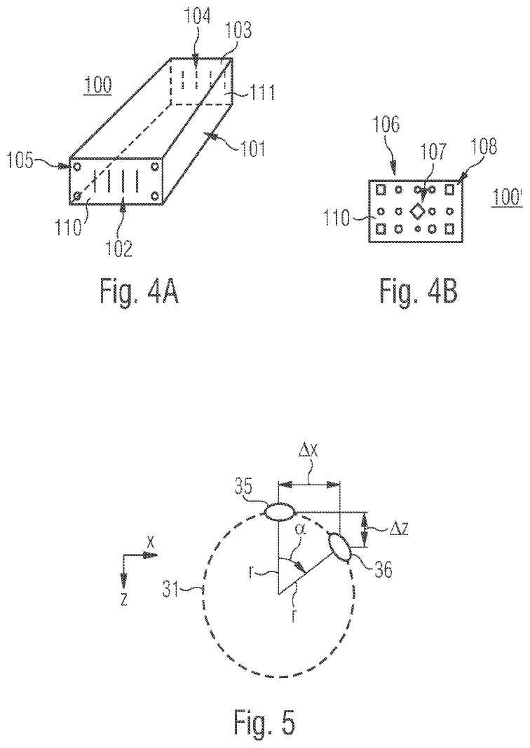

FIG. 4A shows a first embodiment of such a light field measurement device 100 in a perspective illustration. The light field measurement device 100 has a housing 101 which may be configured as a tube, for example. The housing 101 may extend from a measurement side 110 to an image side 111. In a measurement position and/or operating position, the housing 101 may be aligned perpendicularly to the x-y plane and in parallel with the z plane such that its measurement side 110 faces the centering device 10 (cf. FIG. 1).

In the measurement side 110, at least one diaphragm 102 is formed. In the exemplary embodiment shown in FIG. 4A, multiple slit-shaped diaphragms 102 which may be aligned vertically (i.e. in parallel with the y axis) are formed in the measurement side 110.

At the end facing away from the measurement side 110, the housing 101 has the image side 111 on which a diffusion disk 103, canvas and/or similar image-forming element may be formed, for example. An image 104, generated by the light field, of the respective diaphragm opening is generated onto the diffusion disk 103. The position of this image 104 may be recognized, manually read and/or acquired, for example. Alternatively or additionally, a light field measurement device 100 may instead be used which allows for automatic acquisition, e.g. by means of a photosensor in place of the diffusion disk 103.

FIG. 4B shows a second embodiment of a light field measurement device 100′ in a front illustration. The measurement side 110 of the light field measurement device 100′ has multiple diaphragms 106 which may be configured to be approximately rhomboid, approximately cuboid and/or approximately circular. Apart from this, the light field measurement device 100′ may substantially correspond to the light field measurement device 100 shown in FIG. 4A.

Here, the number, position and configuration of the openings and/or diaphragms 102, 106 may be adapted to respective assumptions about the light field:
On the assumption that the light field only has a tilt, i.e. a prismatic component, a diaphragm opening may be sufficient. Then, a conclusion can be drawn from the deviation in the position of the image 104 from the expected position of the image and the length of the housing 101, i.e. the distance between the diaphragm 102, 106 in the measurement side 110 and the diffusion disk 103 and/or a corresponding image capturing unit of the image side 111, if applicable taking into account possibly existing optics, directly to the global tilt angle. The expected position of the image generally corresponds to the position on the image side 111 on which the image would be positioned if the diaphragm 102, 106 were to be illuminated by the setpoint light field.
On the assumption that the light field has a pure defocus component, a diaphragm opening may also be sufficient. It may be arranged spaced apart from the axis of the fixation target 40 when measuring. Then, a conclusion can be drawn from the distance of the diaphragm opening from the axis of the fixation target 40, the deviation in the position of the image from the expected position of the image (see above) and the length of the housing 101 (see above) directly to the local tilt angle.
Analogously thereto, in the case of a combination of two diaphragm openings and/or measurements, both a tilt and a defocus term may be measured. Here, ascertaining a crossing point in a plane and/or a crossing line in space where all beams or beam planes of the light field cross one another is particularly advantageous. The crossing point and/or the crossing line may be ascertained from the positions of the diaphragm openings and the respectively generated images 104.
For higher order components, further diaphragm openings and/or measurements may be made accordingly.

If the measurement side 110 has multiple diaphragm openings 102, 106, or if multiple measurements are performed than are at least necessary, the measurement accuracy and/or reliability of the ascertained parameters of the light field can be improved. Additionally, further deviations of the light field may be detected here.

If a height-independent light field is assumed, as already explained above, an arrangement of diaphragms 102 in a kind of comb of 3, 5, 7, 9, 10, . . . or 100 line-shaped diaphragm openings may be used (cf. FIG. 4A). From this, the corresponding parameters of the representation of the light field and/or corresponding table values may be determined.

If a height-dependency of the light field is to be taken into account, a matrix may be used at the point-shaped openings (e.g. 3×3 to 100×3; 3×5 to 100×5; or also to 100×100), cf. FIG. 4B for a 3×5 matrix, for example.

In order to simplify unambiguous assignment, in particular with a larger number of diaphragm openings and/or largely tilted, convergent or divergent light fields, the diaphragm openings may be configured to be opened and/or closed in a controlled manner. Individual diaphragm openings may have special geometries. Here, individual diaphragms may be configured as rhomboid diaphragms 107, as square diaphragms 108, as circular diaphragms, as a horizontal beam, as a vertical beam, as diaphragms of different degrees of transparency (which cause a different image brightness) and/or as color filter diaphragms, for example.

When using longer housing tubes of the light field measurement device 100, 100′, the images of the diaphragm openings for different heights, i.e. for different y coordinates, may overlap and/or their shape may be unrecognizable since in this direction, the images may be smeared out by the radiation which is diffuse in this directional component. In this case, the center of gravity of the intensity may be taken as the position, or only diaphragms with non-overlapping images may be opened in each case and, if necessary, several measurements may be performed with differently opened diaphragms.

In some embodiment, the light field measurement device has imaging optics, and/or a measurement camera without any diaphragm is used for this purpose.

In the simplest case, a lens may be used in whose focal plane a light-sensitive chip may be arranged. This approximately corresponds to a camera set to infinity. From the image generated by the fixation target 40 in this light field measurement device, a conclusion can then be drawn to the light field. Ideally, the entire measurement region can be measured and/or imaged in this case.

In the case of a merely prismatic deviation of the fixation target, a conclusion can be drawn from the distance of the image, which is line-shaped, for example, from the center of the imaging optics directly to the propagation direction of the light field.

When there is a (e.g. additional) defocus component in the light field of the fixation target, a conclusion can be (e.g. additionally) drawn from the size of the image to the magnitude of the convergence and/or divergence. To this end, either the size of the image in the x direction, e.g. as the range of intensity above a relative maximum or an absolutely defined threshold value, or the intensity distribution in the x direction may be evaluated, for example. If a component of spherical aberration is present, that is, in a spherical lens without defocus, for example, the same procedure may be adopted.

Combined imaging errors, that is, a defocus component and a spherical deviation, for example, may be derived from the intensity distribution of the image. To this end, a (height-independent) intensity function I_{target}(x) of the following form may be adapted to an intensity distribution Iₘₑₐₛᵤᵣₑₘₑₙₜ(x) measured by means of the light field measurement device, for example:

$${I}_{target} ( x ) = {\sum }_{i} {I}_{i} ( x , {p}_{i} ) \qquad [ M1 ]$$

Here, Iᵢ(x,pᵢ) represents the intensity distribution respectively generated by a component i, that is, by the defocus or the spherical aberration, for example, depending on the x coordinate x. Here, each component i may depend on a (height-independent) parameter and/or set of parameters pᵢ, e.g. on the magnitude of the defocus and/or the magnitude of the spherical aberration. Here, adaptation of the intensity function I_{target}(x) to the measured intensity distribution Iₘₑₐₛᵤᵣₑₘₑₙₜ(x) may take place by setting and/or measuring and/or varying the values for the parameter(s) pᵢ.

If the width of the light source 41, that is, the luminous line, for example, influences the intensity distribution of the light field, this may be taken into account accordingly, e.g. by folding and/or unfolding the intensity function with the radiation characteristic of the light source 41.

The similar applies when the light field of the fixation target 40 is not translation-symmetrical with the y axis. When measuring the light field, the diffuse radiation of the light source 41 in the y direction may be taken into account, by adaptation of a height-dependent intensity function

I_{target}(x,y)=ΣᵢIᵢ(x,pᵢ(y)) [M2]

by setting and/or measuring and/or varying the height-dependent parameters pᵢ(y) analogously, for example, by folding and/or unfolding this height-dependent intensity function with the radiation characteristic of the light source 41 in the y direction, e.g. typically Cos⁴.

A further aspect relates to the distinction between different signs of imaging errors. In the defocus component, it is not possible, for example, to distinguish between a convergent and a divergent light field based on the intensity distribution in the image. Here, a corresponding imaging error may be introduced into the optics of the light field measurement device as an offset and/or a camera may be set accordingly. If the light field of a fixation target 40 has a convergence and/or divergence in the range of +5 dpt to −5 dpt, for example, the optics may contain a defocus of +6 dpt (or −6 dpt), for example, to shift the convergence and/or divergence of this light field to the range of +1 dpt to +11 dpt (or −1 dpt to −11 dpt). In this range, a spot size and/or the intensity course can then be uniquely assigned to a convergence and/or divergence and quantitatively evaluated.

The exemplary description herein regarding the defocus components applies analogously to other components. Thus, a prismatic component, for example, may be evaluated by means of optics.

Independently of the type and/or the exact structure of the light field measurement device used for measuring the light field of the fixation target 40, the light field measurement device should be applied to the fixation target 40 and/or the centering device 10 in a controlled and/or calibrated manner.

This may be achieved, for example, by corresponding supports and fits 105 (cf. FIG. 4A) with tongue-and-groove connections between the light field measurement device 100, 100′, on the one hand, and the fixation target 40 and/or the centering device 10, on the other hand.

In general, the light field measurement device 100, 100′ and/or the fixation target 40 and/or the centering device 10 may have alignment means (such as the fits 105, for example) which support, allow for and/or ensure controlled alignment of the light field measurement device 100, 100′ relative to the fixation target 40 and/or to the centering device 10.

These alignment means may be designed so as to prevent and/or reduce rotation of the components with respect to one another, for example by an asymmetrical arrangement and/or different shapes of the tongue-and-groove fits. The alignment means may be designed to be multiple and/or periodic to allow for multiple placements with different, predefined distances.

If the axis of the centering device 10 is determined by a mirror 26 in which the spectacle wearer 30 can observe themselves, the alignment of the light field measurement device 100, 100′ may be realized by a support surface which rests flush on the mirror surface in the measurement posture. Here, the axis of the light field measurement device 100, 100′ may be aligned perpendicularly to the mirror surface.

If the presence of a prismatic component of the light field of the fixation target 40 can be excluded, laterally correct application is not required. This can facilitate the arrangement of the light field measurement device 100, 100′ in the measurement posture.

As an alternative or in addition to the measurement of the generated light field, elements and/or pre-assembled modules constituted by multiple elements of the fixation target 40 may be measured to ascertain the light field therefrom. Here, all or only one or multiple elements or modules may be measured, in particular the element(s) having the highest (production) tolerance and/or whose tolerance has the greatest impact on the light field.

For the exemplary case that the light source 41 and the tube-shaped housing 101 can be produced with sufficient accuracy for aligning the rod-shaped light source 41 with the cylindrical lens 42 and with the centering device, but the cylindrical lens 42 has an excessively wide production tolerance, e.g. with regard to the axial position of the focal line, focal length and/or the lateral position (e.g. due to a wedge error and/or shifting of the vertex), the geometry of the cylindrical lens 42 and/or directly its imaging properties may be measured and, from this information as well as the data on the remaining elements of the fixation target 40, the prospective properties of the light field may be derived, for example in the form of the position of the line where the beams of the light field intersect one another.

Furthermore, for example, at least one surface of the cylindrical lens 42, e.g. the convex surface in the case of a plano-convex lens, may be measured and parameters for describing the generated light field may be derived therefrom, e.g. as a Zernike coefficient.

Here, the measurements may, in each case, be performed either individually on the respective individual element and/or module, or on one or more which are representative of a batch. Here, an average value or median value of multiple elements and/or modules may be used, for example.

In a further embodiment, purely theoretical values may be used. This may be done, for example, when the cylindrical lens 42 contains known imaging errors, such as spherical aberrations, for example, which can be compensated for in this manner.

In this way, design and/or production-induced erroneous fittings may be compensated for, e.g. deviations in the position of the light source 41 from the focal line of the cylindrical lens 42.

Calculation and/or Correction of the Parameters to be Measured

In the following description, it is assumed that in measurement by means of the centering device 10, a horizontal component of the eye posture of the spectacle wearer 30 corresponds to the horizontal component of the direction of the generated light field.

A deviation of the actual direction of the horizontal component of the direction of the light field from the setpoint direction of the desired setpoint light field at the measurement location, that is, at the location of the pupil of the spectacle wearer 30, for example, is hereinafter referred to as a signed tilt angle α.

The erroneous displacement, i.e. rotation, of the eye in the horizontal corresponds to the deviation of the direction of the horizontal component of the direction of the light field, and is thus also α.

In order to calculate the measurement position of the eye, the eye radius of the eye of the spectacle wearer 30 may be used. The eye radius may be denoted by r. It may be assumed to be generic, for example, as explained in detail in DIN e.V.: DIN EN ISO 5340, “Begriffe der physiologischen Optik” (“Terms in physiological optics”), April 1998 or in C. W. Oyster: “The Human Eye”, 1999, for example. However, the eye radius r may also be estimated from other parameters of the eye, e.g. from the visual defect, specifically according to a linear relationship which is explained in detail, for example, in C. W. Oyster: “The Human Eye”, 1999, or it may be measured in another way, which is explained, for example, in S. Trumm et al.: “Helligkeitsabhängige Anpassung eines Brillenglases” (“Brightness-dependent fitting of a spectacle lens”), DE 10 2011 120 974 A1, or it may be determined, which is explained, for example, in S. Trumm et al.: “Belegung eines Augenmodells zur Optimierung von Brillengläsern mit Messdaten” (“Assignment of an eye model for optimizing spectacle lenses with measurement data”), DE 10 2017 007 975 A1.

FIG. 5 shows the eye 31 of the spectacle wearer 30 in a schematic illustration. The pupil of the eye 31 should be located in the setpoint position 35 when viewing the setpoint light field. Actually, it is located in the measurement position 36 when viewing the actual light field. A direction vector from the ocular center of rotation and/or from the ocular center point to the setpoint position 35 is rotated with respect to a direction vector from the ocular center of rotation and/or from the ocular center point to the measurement position 36 by the tilt angle α.

Thus, for the deviation in the measurement position 36 of the pupil in the horizontal perpendicular to the axis of the fixation target 40, i.e. for the horizontal lateral deviation Δx, this results in, also signed:

$$Δ x = sin ( α ) * r \qquad [ G1 ]$$

In the direction of the axis of the fixation target 40, the distance of the pupil from the centering device 10 increases by the horizontal front deviation Δz with:

$$Δz = ( 1 - cos ( α ) ) * r \qquad [ G2 ]$$

The deviation of the measurement position 36 from the setpoint position 35 is thus composed of at least the horizontal lateral deviation Δx and the horizontal front deviation Δz. The horizontal lateral deviation Δx and the horizontal front deviation Δz may be a constituent part of the deviation information which may be stored in the correction unit. Alternatively or additionally, the tilt angle α may be present as deviation information, e.g. in combination with the eye radius r. Then, the horizontal lateral deviation Δx and the horizontal front deviation Δz may be calculated by the correction unit.

In one embodiment, the centering device 10 may acquire the depth (z) and the lateral position of the pupil (x and y) and thus the measurement position 36, e.g. by means of a calibrated stereo camera system, directly from the image data, as in R. Sessner et al.: “Vorrichtung und Verfahren zum Bestimmen von optischen Parametern eines Benutzers; Computerprogrammprodukt” (“Device and method for determining optical parameters of a user; Computer program product”), DE 10 2005 003 699 A1.

If the centering device 10 has only one camera, for example, or if it is not calibrated, the exact measurement position 36 of the pupil often cannot be directly acquired. In this case, however, the following procedure may be adopted, for example: In a first step, the distance (z coordinate) may be derived, for example, from the size of a reference object, e.g. a clip-on bracket, in the image of the camera and/or the position of a stationary reference object in the image of the camera and/or data from the focusing of the camera. Furthermore, a given distance (z coordinate) based on a positional specification for the spectacle wearer 30 may be used. From this distance and/or the above-mentioned parameters and/or imaging properties of the camera, the lateral position of the pupil (x and y) may be ascertained. Thus, the measurement position is ascertained.

The direction of the beams of the light field may be determined at the measurement location, that is, at the location of the pupil, for example. To this end, in a first step, the direction of the beams of the light field and thus the deviation of the direction of the beams of the light field from the setpoint direction, i.e. the direction of the beams of the setpoint light field, may be determined.

This may be done, for example, as stated in Table 1:

TABLE 1
Determining the direction of the beams of the light field at the location of the pupil

| Deviation of the light field | Deviation independent of the | Deviation dependent on the |
|---|---|---|
| and description | height (ascertainment in 2D) | height (ascertainment in 3D) |
| Purely prismatic deviation | α is constant over the entire | Select/calculate α depending |
| | range, no further | on the height |
| | calculations required | |
| Defocus deviation with or | Ascertain α from the | Ascertain α from the |
| without prismatic deviation; | direction from the | direction from the |
| description by point/line | ascertained pupil position to | ascertained pupil position to |
| where the beams intersect | the intersection of the beams | the intersection of the beams |
| one another | | in the horizontal plane |
| | | corresponding to the height |
| | | of the ascertained pupil |
| | | position y, or to the |
| | | intersection of the line with |
| | | the horizontal plane |
| | | containing the pupil position |
| Any deviations, represented | Calculation from the | Calculation from the |
| as coefficients/parameters | coefficients or parameters | coefficients for the |
| (e.g. Zernike) | and the ascertained pupil | horizontal plane in which the |
| | position | ascertained pupil is located, |
| | | or directly in space. |
| Any deviations, represented | Evaluating the function ƒ(x, z) | Evaluating the function |
| as a function ƒ. | at the ascertained pupil | ƒ_{y}(x, z) for the horizontal |
| | position | plane in which the pupil is |
| | | located, or the function |
| | | ƒ(x, y, z) in space at the |
| | | ascertained pupil position |
| Any deviations, represented | Evaluating the table at the | Evaluating the table at the |
| as a table | ascertained pupil position | location of the ascertained |
| | (closest value or | pupil position (closest value |
| | interpolation) | or interpolation) |

In the following, it will be described how to correct the measurement position to the setpoint position, in particular the measurement position of the pupil to the setpoint position of the pupil.

As described, the measurement position of the pupil, that is, (xₘₑₐₛᵤᵣₑₘₑₙₜ, zₘₑₐₛᵤᵣₑₘₑₙₜ), for example, deviates from the setpoint position of the pupil, that is, (xₛₑₜₚₒᵢₙₜ, zₛₑₜₚₒᵢₙₜ), for example, by the deviation (Δx, Δz):

$${x}_{measurement} = {x}_{setpoint} + Δ x \qquad [ G3 ]$$

$$and$$

$${z}_{measurement} = {z}_{setpoint} + Δ z$$

Thus, together with [G1] and/or [G2], for calculating the corrected setpoint position (xₛₑₜₚₒᵢₙₜ, zₛₑₜₚₒᵢₙₜ), this results in:

$${x}_{setpoint} = {x}_{measurement} - sin ( α ) * r \qquad [ G4 ]$$

$$and$$

$${z}_{setpoint} = {z}_{measurement} - ( 1 - cos ( α ) ) * r$$

In practice, this may be simplified, depending on the demands for accuracy: If the calculation is always carried out with a fixed eye radius r and a constant tilt angle α, i.e. a purely prismatic displacement, the horizontal deviations (Δx and/or Δz) may be precalculated as fixed parameters and thus calculated with a flat-rate offset. For small displacements, small-angle approximation may be used.

At least the following optical centering parameters and/or individual parameters, as defined, for example, in DIN e.V.: DIN EN ISO 13666: “Begriffe der physiologischen Optik” (“Terms in physiological optics”), December 2019, may be derived from the position of the pupil and, if necessary, the points of the spectacle frame relevant in each case:
the monocular pupillary distance;
the fitting height;
the overall pupillary distance (e.g. in measurements on both eyes);
the corneal vertex distance;
the forward inclination in the posture of use;
the face form angle in the posture of use.

Since these optical centering parameters depend on the position of the pupil, at least one, preferably multiple or even all of them, are calculated by the parameter calculation unit on the basis of the corrected setpoint position of the pupil.

By means of the deviation information, the centering device 10 may be used for ascertaining the position of the ocular center of rotation and/or to ascertain it additionally or instead of the corrected pupil position. This may be done e.g. according to one of the following two methods: For the first method, a previously ascertained or set eye radius r is used, cf. the above explanations. A vector having the length r and the direction of the light field at the location of the ascertained, uncorrected pupil position (i.e. the measurement position) is applied to the location of the ascertained, uncorrected pupil position. The end point of the vector then denotes the position of the ocular center of rotation.

In the second method, an eye radius is not needed but may be determined additionally. Two pictures with different positions and/or orientations of the face of the spectacle wearer 30 are taken. For each picture, a straight line is placed through the respective uncorrected pupil position (i.e. measurement position) with the respective direction of the light field at the location of the respective uncorrected pupil position. Both straight lines are transferred to a coordinate system fixed with respect to the head. The position and orientation of the head of the spectacle wearer 30 in the respective pictures may be derived based on specific properties of the face and/or the frame, or reference objects attached to the face or to the frame. The intersection of the two straight lines in the coordinate system fixed with respect to the head amounts to the ocular center of rotation. In skew lines due to measurement inaccuracies, the point with the smallest distance from both straight lines may be taken as the intersection.

By using more than two pictures, the accuracy and/or certainty of the measurement can be enhanced. Here, each picture results in a straight line. Now, the point with the smallest distance to all straight lines can be ascertained as an ocular center of rotation. Here, straight lines which are too far away from the intersections of the other straight lines may be excluded from the evaluation.

A calculation of the corrected pupil position is not required in both cases when it is the centering parameter to be ascertained, or further centering parameters, possibly in conjunction with the eye radius, are derived.

Instead or in addition to the position of the pupil, the position of the corneal vertex may be taken into account. So far and in the following, the terms of the location of the pupil, the position of the pupil and the pupil position are used for the sake of clarity. This can be understood as the center point of the circle inscribing or circumscribing the pupil, its center of gravity or another geometrical dimension.

Furthermore, in general, i.e. in the above and following sections, the corneal vertex or other objects of the eye may also be used instead of the pupil. That is, instead of the position of the pupil, the position of the corneal vertex may be ascertained, and the direction of the light field may be implemented instead of the pupil. Furthermore, the position of the pupil, e.g. according to a metric as above, may also be acquired and corrected, but the position of the corneal vertex or the position of the pupil according to another metric may be used for evaluating the light field, or vice versa.

To this end as well, the position of the corneal vertex can be derived from the position of the pupil and vice versa. For this purpose, the relation between the two elements described in W. Wesemann: “Mejβgenauigkeit und Reproduzierbarkeit von PD-Meβgeräten und Unterschiede zwischen der Zentrierung auf Pupillenmitte bzw. auf Hornhautreflex” (“Measurement accuracy and reproducibility of PD measuring devices and differences between the centering to the pupil center or to the corneal reflex”), DOZ 2/97 may be used.

Furthermore, the position of the corneal vertex and the pupil may be determined or corrected independently of one another.

In both of these methods, a correction of the pupil position is not necessary.

In the description so far, it has been assumed that the light field is diffuse in the vertical direction. However, the invention may also be applied in cases where this is not the case, i.e. where the fixation target is not exactly vertically aligned, for example.

That is, the fixation target 40 may also be arranged in a manner rotated about its own axis, i.e. the z axis. In this case, when determining the deviation of the fixation target 40 and evaluating the measurements, the coordinate system is to be rotated accordingly so that a correction is made in the direction in which the fixation target 40 causes the displacement while not causing any displacement in the direction perpendicular thereto by the diffuse radiation.

Any rotation of the fixation target 40 about this axis may be performed analogously to the above description. When using the light field measurement device 100, 100′, the direction of the diffusely luminous component (y direction) may be ascertained from the direction of the line which generates a round diaphragm opening. The x direction is then the perpendicular thereto. Depending on the configuration, it may also be ascertained directly as the direction of the smallest extent of the image of a circular diaphragm opening.

The light field may (unlike the description so far) also be defined in both spatial directions, i.e. not have any completely diffuse directional component, e.g. to align the eye in both the horizontal and the vertical. Further, the fixation target 40 may generate a directed light field due to its small extent even when it is diffusely luminous, e.g. when it only consists of a luminous point.

The deviation of the light field from the setpoint light field, that is, from a parallel light bundle, for example, may be specified for each point in space, not only for the deviation of a directional component but for the deviation in space. This may be done, for example, by specifying both components (horizontal and vertical) of a (standardized) direction vector or corresponding angles.

The previous description above of the light field may be correspondingly extended for this purpose. This may be facilitated, if necessary, when the light field of the fixation target 40, or its deviations, satisfy or satisfies certain conditions in this context. For example, all beams may converge in one point, or the light field may be described by components such as defocus and spherical aberration, for example.

In the evaluation, the displacement of the eye in all three spatial directions may accordingly be taken into account, except when the z direction is neglected on purpose, for example. To this end, the direction of the light field in space at the measurement location, e.g. at the location of the pupil or the apex, may be evaluated correspondingly, and the position of the pupil or the apex may be corrected.

The shift in the position of the pupil or the apex may be calculated via the transformation with the corresponding rotation matrices, for example, or from the transformation of the coordinates of the position of the pupil from polar coordinates, i.e. the angle of the light field and the radius of the eye.

The corrected pupil positions, i.e. setpoint positions, result from the correction by the displacement of the eye analogously to [G3] and [G4] in the three spatial directions for:

$${x}_{measurement} = {x}_{setpoint} + Δ x \qquad [ G5 ]$$

$$and$$

$${y}_{measurement} = {y}_{setpoint} + Δ y$$

$$and$$

$${z}_{measurement} = {z}_{setpoint} + Δ z$$

With a and R as local directions of the light field and thus the angular displacement of the eye from the z direction in the x-z plane and y-z plane, respectively, there are obtained:

$${x}_{setpoint} = {x}_{measurement} - sin ( α ) * cos ( β ) * r \qquad [ G6 ]$$

$$and$$

$${y}_{setpoint} = {y}_{measurement} - sin ( β ) * cos ( α ) * r$$

$$and$$

$${z}_{setpoint} = {z}_{measurement} - ( 1 - cos ( α ) * cos ( β ) ) * r$$

The design of an ocular center of rotation is made analogously to the above description with the following differences: In the first method, the vector with the length r—corresponding to the direction of the light field—does no longer have to be in the horizontal plane but may have a horizontal (x direction) and a vertical component (y direction). In the second method, the straight line—corresponding to the directions of the light field—prior to the transfer to the coordinate system fixed with respect to the head—does not have to be in the horizontal plane, i.e. may also have one in the y direction in addition to the x direction.

The calculations described above may be performed by means of the correction unit to correct the measurement position to the setpoint position.

### LIST OF REFERENCE NUMERALS

10 Centering device
12 Housing
14 First image capturing unit
16 Second image capturing unit
18 Monitor
20 First effective optical axis
22 Second effective optical axis
24 Intersection
26 Mirror
28 Illumination means
30 Spectacle wearer
31 Eye
35 Setpoint position
36 Measurement position
40 Fixation target
41 Light source
42 Cylindrical lens
50 Light beams
100 Light field measurement device
100′ Light field measurement device
101 Housing
102 Diaphragm
103 Diffusion disk
104 Image
105 Fit
106 Diaphragm
107 Rhomboid diaphragm
108 Square diaphragm
110 Measurement side
111 Image side
Δx Horizontal lateral deviation
Δz Horizontal front deviation
r Eye radius

1-17. (canceled)

18. A centering device for determining optical centering parameters of a spectacle wearer, comprising:
a fixation target configured to generate a flatly extended light field at a measurement location for illuminating at least one eye of the spectacle wearer;
a measurement unit configured to ascertain at least one measurement position of the at least one eye of the spectacle wearer when viewing the light field generated by the fixation target;
a correction unit, comprising:
deviation information about a deviation of the light field actually generated at the measurement location by the fixation target from a setpoint light field predetermined at the measurement location,
wherein the correction unit is configured to correct the ascertained measurement position of the at least one eye when viewing the light field actually generated at the measurement location, taking into account the deviation information, to a setpoint position of the at least one eye which the at least one eye would prospectively adopt at the measurement location if it were to view the predetermined setpoint light field there; and
a parameter calculation unit operable to ascertain, based on the setpoint position of the at least one eye, at least one of the optical centering parameters to be determined.

19. The centering device according to claim 18, wherein the fixation target is configured such that electromagnetic radiation of the light field is configured to be substantially diffuse in a first predeterminable plane, and to be substantially parallel in a second predeterminable plane which is arranged approximately perpendicular to the first plane.

20. The centering device according to claim 18, wherein the deviation information comprises a deviation of the light field generated at the measurement location from the setpoint light field predetermined at the measurement location in a component selected from a group of components consisting of:
a deviation in a prismatic component;
a deviation in a defocus component; and/or
a deviation in a higher order component,
wherein each one of this component is configured to be height-dependent or height-independent.

21. The centering device according to claim 18, wherein the deviation information comprises a description of the light field generated at the measurement location as a location-dependent function and/or as a location-dependent value table at reference positions.

22. The centering device according to claim 21, wherein the location-dependent function and/or the location-dependent value table specifies at least one angle of the generated light field and/or at least one direction vector of the generated light field.

23. The centering device according to claim 18, wherein the ascertained measurement position of the at least one eye when viewing the light field actually generated at the measurement location comprises an erroneous displacement of the at least one eye which comprises a horizontally aligned erroneous displacement angle.

24. The centering device according to claim 18, wherein the correction unit is configured to correct the ascertained measurement position of the at least one eye taking into account an eye radius in one or in two or in three dimension(s).

25. The centering device according to claim 24, wherein the correction unit is configured to ascertain the eye radius from data acquired by the measurement unit and uses the radius when correcting the measurement position of the at least one eye.

26. The centering device according to claim 18, wherein the measurement position and/or the setpoint position of the at least one eye comprises a pupil position, a corneal vertex position and/or an ocular center of rotation.

27. The centering device according to claim 18, further comprising:
a parameter determination unit configured to ascertain a parameter as an optical centering parameter and/or as an individual parameter from the setpoint position, from a group of parameters consisting of:
a monocular pupillary distance;
a fitting height;
a binocular pupillary distance;
a corneal vertex distance;
a forward inclination in posture of use; and/or
a face form angle in the posture of use.

28. A method for determining optical centering parameters of a spectacle wearer, comprising:
generating a flatly extended light field at a measurement location for illuminating at least one eye of the spectacle wearer using a fixation target;
ascertaining at least one measurement position of the at least one eye of the spectacle wearer when viewing the light field generated by the fixation target;
providing deviation information about a deviation of the light field actually generated at the measurement location by the fixation target from a setpoint light field predetermined at the measurement location;
correcting the ascertained measurement position of the at least one eye when viewing the light field actually generated at the measurement location, taking into account the deviation information, to a setpoint position of the at least one eye which the at least one eye would prospectively adopt at the measurement location if it were to view the predetermined setpoint light field there; and
calculating, based on the ascertained setpoint position of the at least one eye, at least one of the optical centering parameters to be determined.

29. The method according to claim 28, wherein the light field actually generated at the measurement location by the fixation target is measured using a light field measurement device to provide the deviation information.

30. The method according to claim 29, wherein the light field measurement device has at least one diaphragm and/or one imaging optics and/or one measurement camera without any diaphragm.

31. The method according to claim 29, wherein the light field measurement device is aligned relative to the fixation target and/or to components of the fixation target in a controlled manner prior to measurement of the light field generated at the measurement location.

32. The method according to claim 28, wherein:
light-influencing components of the fixation target are measured,
contributions to the light field generated at the measurement location which are generated by said components are estimated, and
the contributions of the components are incorporated into the deviation information and/or said contributions are used as the deviation information.

33. The method according to claim 28, wherein at least one contribution of at least one light-influencing component of the fixation target to the deviation information is previously known and is incorporated into the deviation information without being measured and/or the at least one contribution is used as the deviation information without being measured.
